(19) United States
(12) Patent Application Publication
(10) Pub. No.: US 2009/0139771 A1
(43) Pub. Date: Jun. 4, 2009

(54) Method of making drilling fluids containing microbubbles

(76) Inventors: Kevin W. Smith, Houston, TX (US); Taylor C. Green, Houston, TX (US)

Correspondence Address: William L. Krayer, 1771 Helen Drive, Pittsburgh, PA, 15216, US

(21) Appl. No.: 12/313,958

(22) Filed: Nov. 26, 2008

Related U.S. Application Data
(60) Provisional application No. 61/004,661, filed on Nov. 29, 2007.

(51) Int. Cl. E21B 7/00; C09K 8/02

(52) U.S. Cl. 175/69; 507/100

(57) ABSTRACT

Light weight drilling fluids are prepared by passing a gas and the drilling fluid through a cavitation device. Bubbles are finely divided into microbubbles, thereby reducing the density of the fluid. Low HLB surfactants, natural polymers, and ionic-charged polymers may be added to enhance the stability of the microbubble suspension.

### RELATED APPLICATION

This application claims the full benefit under 35USC119 and/or 120 of provisional application 61/004,661 filed Nov. 29, 2007 which is hereby specifically incorporated herein in its entirety.

### TECHNICAL FIELD

Microbubbles are created and dispersed in fluids used for drilling wells. The microbubbles are useful for any drilling fluid, but are particularly suited for creating light to middle weight aqueous fluids in the range of 4-6 pounds per gallon. Fluids in this range find use mainly in underbalanced drilling. The microbubbles are created by a cavitation device upstream of the high pressure pump which circulates the fluid in the well.

### BACKGROUND OF THE INVENTION

In the drilling of wells for hydrocarbon recovery, fluids are circulated in wellbores during drilling, primarily to remove drill cuttings. The fluids can range in weight from very near zero (gas) to as high as 24 pounds per gallon, for which weighting agents are added to impart a high specific gravity to assure the cuttings will have buoyancy in the fluid. A major factor in the choice of the weight of the fluid over this wide range is the pressure in the formation through which the wellbore is drilled. As a general rule, where the pressure in the formation is high, a heavier fluid will be used; if the pressure in the formation is relatively low, a lighter weight fluid will be prescribed for a balanced or underbalanced drilling process, in order not to injure the formation. A lighter fluid may be desirable also if the wellbore passes through a stratum of relatively low pressure even though the pressure may increase at greater depths, in order not to lose fluid unnecessarily into the formation in the low pressure area. In either case, the pump that circulates the fluid must be able to overcome the pressures of the formation as well as circulate the fluid. A triplex pump is commonly used for injecting and circulating the drilling fluid in the well.

Water weighs about 8.33 pounds per gallon, and has been used for decades in many different kinds of drilling environments by itself and as a base for many different kinds of drilling muds. Foaming agents have been used to reduce the weight of various aqueous drilling fluids. The industry has used foams of various types that are effective for limited or specified purposes, but a foam has a high percentage of gas and a small percentage of liquid and accordingly tends to weigh less than 2 pounds per gallon. In many situations, their ability to carry drill cuttings is limited.

Technically foam is a different fluid. Foam is defined as bubbles in contact with one another such that they bubble must deform for the fluid to move. They are true Bingham Plastic fluids typically with a very high yield point and plastic viscosity. While they are very efficient fluids, they are much harder to control. That is, you must control the pressure of the annular space such that the volume of gas does not expand to the point that you exceed the volume limit of the foam where the bubbles interfere with one another. Typically foam is defined as being 62 to 90% gas at a given pressure, and more typically foam that is 75% by volume gas has better fluid properties. There are recently developed methods to control annular pressure, but still there is a pressure differential from the bit to the surface. (We can insert the At Balance patent info here). Controlling the annular pressure is further complicated by the need to remove cuttings from the system. Foam has further disadvantage in high friction pressures. Since the bubbles must deform to move, there is high wall friction inside of the drill pipe. When drilling with foam, it is common to try to make the foam at the drill bit; however, there is less control of the fluid since gravity can cause the gas and liquid to arrive at the bit in slugs.

Light, non-foaming drilling fluids in the range of 4-6 pounds per gallon are desirable in many situations because a lighter hydrostatic column means the drilling can proceed at a faster pace and frequently with less energy expenditure. Such a light, non-foaming, fluid would be able to carry the cuttings efficiently, but is not practically available in the industry.

As is known in the art, aerated drilling systems used in the past (for example, foam systems) inject the air after—that is, downstream of—the triplex pump, because the triplex pump is liable to form large bubbles by coalescing small ones, which can cause major damage to the pump and/or otherwise cause a disruption of the system if the air is injected by conventional means ahead of or in the triplex pump. But air injection systems used in the past have themselves been a large part of the problem. The triplex pump may become locked if a large bubble of air passes into it or is formed within it by cavitation. A practical way of placing bubbles in the fluid to decrease the weight of the fluid downstream of the triplex pump has eluded the art.

Even a centrifugal pump is highly likely to become air locked if more than 6% air by volume is introduced into the pump.

The range of drilling fluid weights from about 4 to about 6 pounds per gallon has been difficult to attain. Likewise, a convenient way of reducing the weight of fluids containing desirable heavy components has eluded the art. My invention provides a method of reducing the weight of virtually any drilling fluid, as well as provides a new type of fluid in the range of 4-6 #/gal.

### SUMMARY OF THE INVENTION

My invention provides a new drilling fluid weighing about 4-6 pounds per gallon. It also provides a method of injecting a gas into a drilling fluid prior to injecting it down a wellbore, and controlling the weight of the fluid during recycle. It also provides a new class of drilling fluid compositions containing microbubbles of substantially uniform size which may be maintained in a dispersed condition while the fluid is in use.

Using microbubbles provides a number of advantages compared to foam, Microbubbles do not need to deform to flow; therefore, the base fluid determines the properties of the microbubble suspension. Furthermore, microbubbles are known to actually reduce friction with some liture claims of 30 to 60 percent friction reduction.

The microbubbles are injected into the drilling fluid by a cavitation device.

Thus my invention includes a method of injecting a drilling fluid having a reduced weight into a wellbore comprising simultaneously feeding a drilling fluid base liquid and a gas to a cavitation device, operating said cavitation device to create bubbles of said gas in said base liquid within said cavitation device, feeding said base liquid containing said bubbles to a pump, and injecting said liquid containing said bubbles into said wellbore from said pump.

My invention also includes a drilling fluid comprising water and non-contiguous microbubbles in an amount sufficient to reduce the weight of the drilling fluid to within the range 4-6 pounds per gallon.

In addition, my invention includes a drilling fluid comprising a liquid, drilling fluid additives, and non-foamed microbubbles having diameters of from 20-40 microns in an amount sufficient to reduce the weight of said liquid and drilling fluid additives by at least 25%.

My invention also includes a method of drilling a well comprising creating microbubbles of gas in a drilling fluid by passing said gas and said fluid through a cavitation device, passing said fluid containing said microbubbles to a pump, circulating said fluid containing said gas from said pump to said well to remove drill cuttings therefrom, and recycling at least a portion of said fluid containing said gas through said cavitation device with additional gas as needed to maintain a desired gas quantity in said fluid.

### BRIEF DESCRIPTION OF THE DRAWINGS

FIGS. 1a and 1b illustrate a cavitation device for making the microbubbles useful in my invention.

FIG. 1c is a similar cavitation device showing the introduction of gas and the formation of microbubbles in a drilling fluid.

FIG. 2 is a flow sheet showing the disposition of the cavitation device at a well site.

### DETAILED DESCRIPTION OF THE INVENTION

As is known in the art, the triplex pump is able to send the drilling fluid down the well to the bottom where the drill is creating cuttings, so the fluid will pick up the cuttings, and raise them to the surface. At the same time, the pump must overcome the formation pressure. The downhole pressure may typically be in the order of 2000 psi or more, causing the microbubbles to be compressed.

Bearing in mind that water weighs about 8.33 ppg, and as my objective is to obtain a fluid in the well having a weight of 4-6 ppg, a gallon of water containing bubbles requires that the bubbles occupy from 28% to 52% of the volume of the fluid before injection, without forming a foam. This would be extremely difficult to do with conventional air or gas injection techniques on the downstream side of the triplex pump, where the pressure is already at the 2000 psi level. Placing this much air or gas in the liquid within the triplex pump or upstream of it with conventional air injection techniques has not been successfully done in the past. Accordingly, I use a cavitation device.

Preferably the cavitation device is one manufactured and sold by Hydro Dynamics, Inc., of Rome, Ga., most preferably the device described in U.S. Pat. Nos. 5,385,298, 5,957,122 6,627,784 and particularly 5,188,090, all of which are incorporated herein by reference in their entireties. In recent years, Hydro Dynamics, Inc. has adopted the trademark “Shockwave Power Reactor” for its cavitation devices, and I sometimes use the term SPR herein to describe the products of this company and other cavitation devices that can be used in my invention.

Definition: I use the term “cavitation device,” or “SPR,” to mean and include any device which will cause bubbles or pockets of partial vacuum to form within the liquid it processes. The bubbles or pockets of partial vacuum have also been described as areas within the liquid which have reached the vapor pressure of the liquid. The turbulence and/or impact, which may be called a shock wave, caused by the implosion imparts thermal energy to the liquid, which, in the case of water, may readily reach boiling temperatures. The bubbles or pockets of partial vacuum are typically created by flowing the liquid through narrow passages which present side depressions, cavities, pockets, apertures, or dead-end holes to the flowing liquid; hence the term “cavitation effect” is frequently applied, and devices known as “cavitation pumps” or “cavitation regenerators” are included in my definition. Steam generated in the cavitation device can be separated from the remaining, now concentrated, water and/or other liquid which frequently will include significant quantities of solids small enough to pass through the reactor. Cavitation devices can be used to heat fluids, but in my invention I use them to make microbubbles which are intended not to implode, but to remain in bubble form. To do this, a gas is injected along with the liquid, and the conditions controlled to generate microbubbles.

The term “cavitation device” includes not only all the devices described in the above itemized U.S. Pat. Nos. 5,385,298, 5,957,122 6,627,784 and 5,188,090 but also any of the devices described by Sajewski in U.S. Pat. Nos. 5,183,513, 5,184,576, and 5,239,948, Wyszomirski in U.S. Pat. No. 3,198,191, Selivanov in U.S. Pat. No. 6,016,798, Thoma in U.S. Pat. Nos. 7,089,886, 6,976,486, 6,959,669, 6,910,448, and 6,823,820, Crosta et al in U.S. Pat. No. 6,595,759, Giebeler et al in U.S. Pat. Nos. 5,931,153 and 6,164,274, Huffinan in U.S. Pat. No. 5,419,306, Archibald et al in U.S. Pat. No. 6,596,178 and other similar devices which employ a shearing effect between two close surfaces, at least one of which is moving, such as a rotor, and at least one of which has cavities of various designs in its surface as explained above.

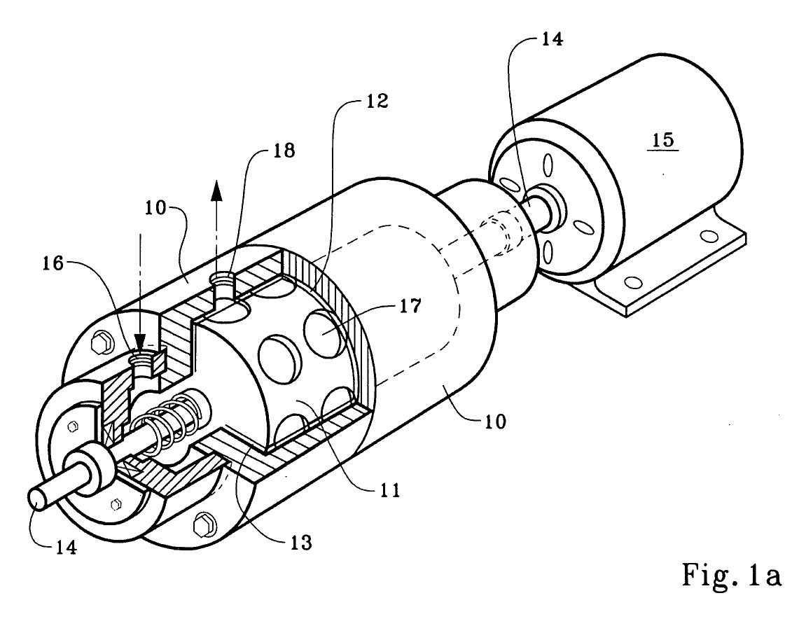

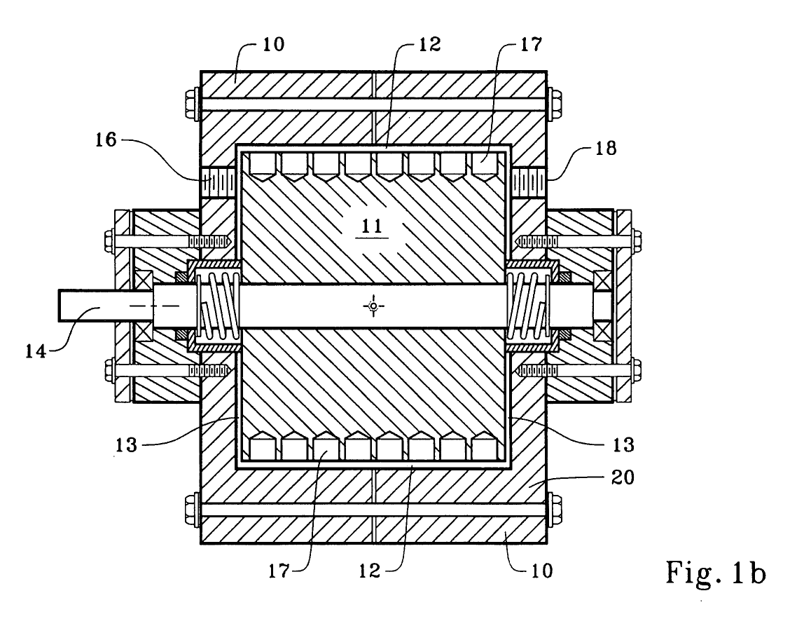

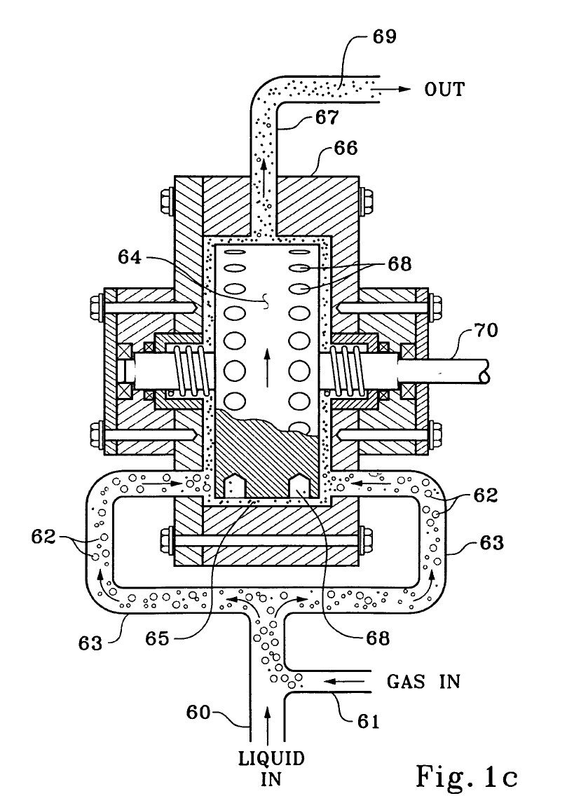

FIGS. 1a and 1b show two slightly different variations, and views, of the cavitation device.

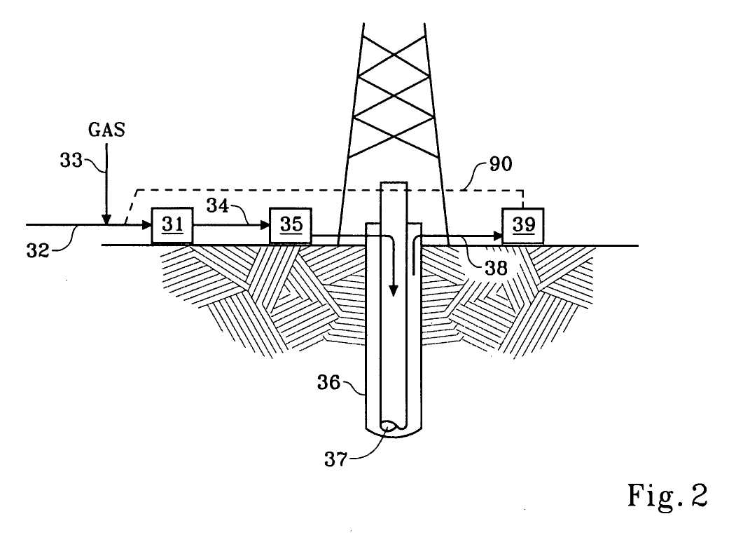

FIGS. 1a and 1b are taken from FIGS. 1 and 2 of Griggs U.S. Pat. No. 5,188,090, which is incorporated herein by reference along with related U.S. Pat. Nos. 5,385,298, 5,957,122, and 6,627,784.

A housing 10 in FIGS. 1a and 1b encloses cylindrical rotor 11 leaving only a small clearance 12 around its curved surface and clearance 13 at the ends. The rotor 11 is mounted on a shaft 14 turned by motor 15. Cavities 17 are drilled or otherwise cut into the surface of rotor 11. As explained in the Griggs patents, other irregularities, such as shallow lips around the cavities 17, may be placed on the surface of the rotor 11. Some of the cavities 17 may be drilled at an angle other than perpendicular to the surface of rotor 11—for example, at a 15 degree angle. Liquid (fluid)—in the case of the present invention, a drilling fluid,—is introduced through port 16 under pressure and enters clearances 13 and 12. As the fluid passes from port 16 to clearance 13 to clearance 12 and out exit 18 while the rotor 11 is turning, areas of vacuum are generated and heat is generated within the fluid from its own turbulence, expansion and compression (shock waves). As explained at column 2 lines 61 et seq in the U.S. Pat. No. 5,188,090 patent, “(T)he depth, diameter and orientation of (the cavities) may be adjusted in dimension to optimize efficiency and effectiveness of (the cavitation device) for heating various fluids, and to optimize operation, efficiency, and effectiveness . . . with respect to particular fluid temperatures, pressures and flow rates, as they relate to rotational speed of (the rotor 11).” Smaller or larger clearances may be provided (col. 3, lines 9-14). Also the interior surface of the housing 10 may be smooth with no irregularities or may be serrated, feature holes or bores or other irregularities as desired to increase efficiency and effectiveness for particular fluids, flow rates and rotational speeds of the rotor 11. (col. 3, lines 23-29) Rotational velocity may be on the order of 5000 rpm (col 4 line 13). The diameter of the exhaust ports 18 may be varied also depending on the fluid treated. Note that the position of exit port 18 is somewhat different in FIGS. 1a and 1b; likewise the position of entrance port 16 differs in the two versions and may also be varied to achieve different effects in the flow pattern within the SPR.

Another variation which can lend versatility to the SPR is to design the opposing surfaces of housing 10 and rotor 11 to be somewhat conical, and to provide a means for adjusting the position of the rotor within the housing so as to increase or decrease the width of the clearance 12. This can allow for different sizes of solids present in the fluid, to reduce the shearing effect if desired (by increasing the width of clearance 12), to vary the velocity of the rotor as a function of the fluid's viscosity, or for any other reason.

Operation of the SPR (cavitation device) is as follows. A shearing stress is created in the solution as it passes into the narrow clearance 12 between the rotor 11 and the housing 10. The solution quickly encounters the cavities 17 in the rotor 11, and tends to fill the cavities, but the centrifugal force of the rotation tends to throw the liquid back out of the cavity. Small bubbles, some of them microscopic, are formed. Where no gas is present, the small bubbles are imploded. The relatively large amount of gas present in the liquid in my invention (see FIG. 2), however, preserves the bubbles as microbubbles.

FIG. 1c is adapted from FIG. 1 of Hudson U.S. Pat. No. 6,627,784, one of the patents incorporated in its entirety by reference. FIG. 1c shows a cavitation device differing slightly from the cavitation device of FIGS. 1a and 1b. In FIG. 1c, drilling mud liquid in conduit 60 is mixed with gas, usually air, from conduit 61. The gas immediately becomes dispersed in the form of bubbles 62 in conduit 63, which is split in two parts to enter the cavitation device at opposite sides of the rotor 64, which is mounted on shaft 70. As illustrated for the similar cavitation device in FIGS. 1a and 1b, the fluid enters clearance 65 and becomes subjected to the cavitation action imparted by passage of the bubble-containing drilling mud between rotating rotor 64, containing cavities 68, and housing 66. The gas immediately is broken into small bubbles which are formed into evenly dispersed microbubbles in the drilling mud 69 before it exits through conduit 67.

The cavitation device should be run at maximum design speed for maximum tip speed. More cavitation is better for mixing. The microbubbles will be substantially uniform in size if the flow rates of the liquid and gas are maintained substantially constant. The triplex or other charge or rig pump will need a certain charge pressure that is up to 150 psi and then will pump the fluid to an order of magnitude higher pressure. Typically the circulating pressure of the well will be 350 to 5000 psi.

Referring now to FIG. 2, a base liquid is introduced to the cavitation device 31 through conduit 32. A gas is also introduced to the cavitation device 31, through conduit 33. Microbubbles of the gas are created in the liquid in cavitation device 31, as described in FIGS. 1a, 1b and 1c. The microbubbles will be substantially uniform in size if the flow rates of the liquid and gas are maintained substantially constant. The liquid containing the microbubbles is directed through line 34 to triplex or other rig pump 35, which feeds the liquid, now a drilling fluid, into the well 36, where it picks up drill cuttings made by the drill 37 and returns them to the surface through line 38. Separator 39 removes drill cuttings and other solids, and the fluid may be returned for recycle to conduit 32 through line 90.

The Shockwave Power Reactor (SPR) is an ideal device for making micro bubbles. Typically it is run at its highest rpm for a given size to maximize tip speed and thus cavitation. The gas and liquid should flow across the rotor cavities so that the gas and liquid are exposed to the cavitation mixing zone.

For best results at startup, one should prime the pumps with liquid and start flowing through the SPR running at speed before introducing gas into the system. That is fluid is forced through the SPR then through the downhole high pressure pump. Once the SPR is running gas is injected just before the SPR where it is mixed into the liquid by cavitation. The controlled cavitation in the SPR creates micro-bubbles in the 100 nanometer to 100 micrometer size range depending on speed and mixing time in the SPR. Because the increased pressure downstream of the pump will tend to compress the bubbles, smaller bubbles are preferred. That is, since gas is compressible and water is not, you must know the pressure of the system to calculate the volume of gas required to make up the final ratio of gas to liquid at bottom hole conditions. Smaller bubbles are a benefit and increase in pressure from the top of the hole to the bottom of the hole helps create smaller bubbles.

For a given volume of gas, by generating micro-bubbles with the SPR, you get far more surface area of gas bubbles. Surface area is a square function; whereas, volume is a cubed function. Therefore, for a known volume of gas, smaller bubbles will mean far greater surface area compared to larger bubbles. This alone is an advantage in maintaining a stable dispersion of micro-bubbles.

### EXAMPLE 1

### Field Demonstration

A field demonstration was successfully performed at a northeast Texas rig. Drilling was begun with a solids-free fluid having a density of 8.7 ppg. A pump pressure of 2000 psi was established at a 500 gpm flow rate. Then the drilling fluid was routed through a cavitation device having a connection for the introduction of compressed air. At first it was difficult to control the balance between the air and liquid because introduction of the air immediately reduced the liquid flow to as much as 25% below the original liquid flow rate. Using an air supply of 120 psi, a balance of liquid flow and air flow was established, resulting in a substantially steady fluid density of 8.0 ppg for several hours, during which standpipe pump pressure was reduced from 2000 psi to 1600 psi with no hole problems. Brief periods of equivalent density as low as 5 pounds per gallon were believed to have occurred.

The formation of micro bubbles can be enhanced by adding surfactants. Since we do not want “foam” we use surfactants that reduce the interfacial tension between the gas and liquid, but do not create voluminous foam structures. Useful surfactants include various products that have a low HLB (hydrophilic/lipophilic balance) such that they disperse in water, or are only slightly soluble in water. As is known in the art, a low HLB surfactant is one which is higher in oil solubility than it is in water solubility, and can be used to make water-in-oil emulsions. We may use N-dodecyl pyrrolidone (“Surfadone LP-300” from International Specialty Products); however, any surfactant low in water solubility (having a low HLB) will perform. We use the term “low HLB value” in its normally accepted sense, to mean the surfactant is more soluble in oil than in water. Even a very small amount of low HLB value surfactant will be effective to a commensurate degree in dispersing the microbubbles in our aqueous fluids; larger amounts are correspondingly more effective, but since each material is somewhat different, the operator should be prepared to note when further increases result in decreasing improvement or a counterproductive side effect.

Furthermore the stability of the micro bubble suspension can be enhanced by viscosity using low shear viscosity-enhancing polymers such as xanthan gum, hydroethylcellulose, carboxymethyl guar, starches, carboxymethylcellulose and other natural polymers and their derivatives. They may be used in combination; a mixture of carboxymethyl cellulose and xanthan gum is effective. The viscosity-enhancing polymer can be added before or after the SPR. Again, a very small amount of viscosity enhancing polymer will be effective to a commensurate degree in enhancing the viscosity of the fluid and correspondingly stabilizing the suspension of microbubbles; larger amounts are correspondingly more effective, but since each material is somewhat different, the operator should be prepared to note when further increases result in decreasing improvement or a counterproductive side effect.

The stability of the micro bubble suspension can also be enhanced by adding a charge to the surface of each bubble. Micro bubbles are being used extensively in the medical profession where stability is important. A number of additives are listed in the literature as being stabilizers for micro-bubble suspensions. One is such stabilizer is poly (allylamine hydrochloride) or PAH. We may use a copolymer of DADMAC/AA (diallyldimethylammonium chloride and acrylic acid); a copolymer of DADMAC/AA (diallyldimethylammonium chloride and acrylamide may also be used, any polymer capable of carrying an ionic charge may be used. Generally any polymer including amine or diallyl dimethyl ammonium chloride units can be used. The most readily available polymers impart an ionic charge by the presence of an ammonium group in the polymer. The cationic quaternary ammonium sites facilitate electrokinetics and electrophoresis commonly referred to as Zeta Potential. Much like the opposite poles of magnets will repel one another similarly charged bubble surfaces will repel one another and help stabilize the suspension of bubbles. As with the low HLB dispersants and the viscosity-enhancing polymers, a very small amount of ionic charge carrying polymer will be effective to a commensurate degree in enhancing the viscosity of the fluid and correspondingly enhancing the stability of the suspension of microbubbles; larger amounts are correspondingly more effective, but since each material is somewhat different, the operator should be prepared to note when further increases result in decreasing improvement or a counterproductive side effect.

The Ideal Gas Law determines the amount of gas required to make up a given volume at any pressure. The bubbles will get smaller with increasing pressure and larger with decreasing pressure. My goal is to maintain the bubbles within a size range such that they remain micron sized bubbles. Practically smaller is better because they will expand in size as the fluid travels from the highest pressure (I assume that would be at the bit) to the lowest pressure (I assume that would be the buoy line) point at the surface.

Since water is practically incompressible, a given density can be calculated by first picking a target weight in pounds per gallon. If you want a certain ppg fluid then you can simply solve (1—desired density/liquid density) to find the volume of gas required; however, you must define the volume of gas by pressure using the Ideal Gas Law, PV=nRT.

I do not know of anyone placing microbubbles in fluids substantially heavier than water. It is counter intuitive; however, the same equation works whether or not you are using water or clear brine having a high density. An advantage in the clear brine is the bubbles may give more “lift” in the heavy fluid. Thus my invention is able not only to reduce the weight of more or less conventional aqueous drilling fluids, but also fluids which are made dense for various reasons by the addition of heavy salts.

I use the terms liquid and base liquid and fluid for their ordinary meanings and for their meanings in the are of drilling wells. It should be understood also that since I do not intend to make foam, the terms non-contiguous and/or non-foam are intended to mean that the microbubbles are dispersed and do not contact each other in significant numbers.

The cavitation device should be run at maximum design speed for maximum tip speed. More cavitation is better for mixing. The triplex pump will need a certain charge pressure that is up to 150 psi and then will pump the fluid to an order of magnitude higher pressure. Typically the circulating pressure of the well will be 500 to 5000 psi.

The gas may be air, nitrogen, or any other convenient gas.

1. Method of injecting a drilling fluid having a reduced weight into a wellbore comprising simultaneously feeding a drilling fluid base liquid and a gas to a cavitation device, operating said cavitation device to create bubbles of said gas in said base liquid within said cavitation device, feeding said base liquid containing said bubbles to a pump, and injecting said liquid containing said bubbles into said wellbore from said pump.

2. Method of claim 1 wherein said base liquid is an aqueous liquid.

3. Method of claim 1 wherein the bubbles created in said cavitation device are substantially uniformly dispersed, and have diameters from 100 nanometers to 100 micrometers when fed to said pump.

4. Method of claim 1 wherein said pump is a triplex pump.

5. Method of claim 1 including adding to said liquid a viscosifying agent.

6. Method of claim 1 including adding to said liquid a low HLB value surfactant.

7. Method of claim 1 wherein said gas is air.

8. Method of claim 1 wherein said gas is at least 90% nitrogen.

9. Method of claim 1 wherein said bubbles occupy at least 28% of the volume of said base liquid fed to said pump.

10. Method of claim 9 wherein said bubbles occupy about 30% to about 70% of the volume of said base liquid fed to said pump

11. Method of claim 1 wherein said bubbles are substantially non-contiguous.

12. Method of claim 1 including adding to said liquid an ionic charge imparting polymer.

13. Method of drilling a well comprising creating microbubbles of gas in a drilling fluid by passing said gas and said fluid through a cavitation device, passing said fluid containing said microbubbles to a pump, circulating said fluid containing said gas from said pump to said well to remove drill cuttings therefrom, and recycling at least a portion of said fluid containing said gas through said cavitation device with additional gas as needed to maintain a desired gas quantity in said fluid

14. Method of claim 13 wherein said desired gas quantity maintained in said recycled fluid is determined by maintaining said fluid at a weight between about 4 and about 6 pounds per gallon of fluid.

15. Method of claim 13 including maintaining in said fluid an amount of a natural polymer or a derivative thereof effective to impart a low shear viscosity to said fluid.

16. Method of claim 13 including maintaining is said fluid an amount of a low HLB value surfactant effective to disperse said microbubbles.

17. Method of claim 13 including maintaining in said fluid an amount of an ionic charge imparting polymer in said fluid effective to impart mutual repellance to said microbubbles.

18. Method of making an aqueous drilling fluid having a density less than that of water comprising (a) adding microbubbles to said aqueous drilling fluid by passing said aqueous drilling fluid through a cavitation device while also adding air to said drilling fluid, thereby creating a suspension of microbubbles in said drilling fluid, and (b) including in said aqueous drilling fluid a low HLB value surfactant.

19. Method of claim 18 including adding to said aqueous drilling fluid a natural polymer low shear viscosity enhancing agent in an amount effective to stabilize said suspension of microbubbles.

20. Method of claim 18 including adding so said aqueous drilling fluid an ionic charge imparting polymer effective to induce mutual repellance to said microbubbles.
